(19) United States
(12) Patent Application Publication
(10) Pub. No.: US 2019/0102324 A1
(43) Pub. Date: Apr. 4, 2019

(54) CACHE BEHAVIOR FOR SECURE MEMORY REPARTITIONING SYSTEMS

(71) Applicant: Intel Corporation, Santa Clara, CA (US)

(72) Inventors: Meltem Ozsoy, Portland, OR (US); Krystof C. Zmudzinski, Forest Grove, OR (US); Larisa Novakovsky, Haiva (IL); Julius Mandelblat, Haifa (IL); Francis X. McKeen, Portland, OR (US); Carlos V. Rozas, Portland, OR (US); Ittai Anati, Haifa (IL); Ilya Alexandrovich, Yokneam Illit (IL)

(21) Appl. No.: 15/721,631

(22) Filed: Sep. 29, 2017

(51) Int. Cl. G06F 12/14; G06F 12/0846; G06F 12/128; G06F 12/0831; G06F 12/0806; G06F 12/1027; G06F 12/0888; G06F 12/1009

(52) U.S. Cl. CPC G06F 12/1408; G06F 2212/282; G06F 12/128; G06F 12/0831; G06F 12/0806; G06F 12/1027; G06F 12/0888; G06F 12/1009; G06F 2212/621; G06F 2212/6046; G06F 2212/65; G06F 2212/684; G06F 2212/301; G06F 2212/1052; G06F 12/0848

(57) ABSTRACT

Cache behavior for secure memory repartitioning systems is described. Implementations may include a processing core and a memory controller coupled between the processor core and a memory device. The processor core is to receive a memory access request to a page in the memory device, the memory access request comprising a first guarded attribute (GA) indicator indicating whether the page is a secure page belonging to an enclave, determine whether the first GA indicator matches a second GA indicator in a cache line entry corresponding to the page, the cache line entry comprised in a cache, and responsive to a determination that the first GA indicator does not match the second GA indicator, apply an eviction policy to the cache line entry based on whether the cache line is indicated as a dirty cache line and accessing second data in the memory device for the page.

The disclosure pertains to computer systems; more specifically, to cache behavior for secure memory repartitioning systems.

### BACKGROUND

Modern processors are designed to protect sensitive data in memory from both hardware and software attacks. Some processors provide cryptographic mechanisms for encryption, integrity, and replay protection. Memory encryption protects the confidentiality of memory-resident data. On the other hand, integrity protection prevents an attacker from causing any hidden modifications to the ciphertext (i.e., encrypted data, as opposed to plaintext which is unencrypted data) in memory, and replay protection eliminates any undetected temporal substitution of the ciphertext. However, controlling access to pages in memory may include certain checks that result in performance overhead. There may be instances where application corrupts a page that is currently being accessed by a hardware component, thereby causing an undesirable result.

### BRIEF DESCRIPTION OF THE DRAWINGS

FIG. 1 is a block diagram illustrating a computing system for implementing secure memory according to one implementation.

FIG. 2A illustrates a translation lookaside buffer (TLB) with a Guarded (G) attribute according to one implementation.

FIG. 2B illustrates a cache with a Guarded Attribute (GA) according to one implementation.

FIG. 3 is a flow diagram of an example method for generating a GA indicator for memory transactions and cache lines in a secure memory repartitioning system according to one implementation according to one implementation.

FIG. 4 is a flow diagram of an example method for comparing GA bits during a cache access in a secure memory repartitioning system according to one implementation according to one implementation.

FIG. 5A is a block diagram illustrating a micro-architecture for a processor in which one implementation of the disclosure may be used.

FIG. 5B is a block diagram illustrating an in-order pipeline and a register renaming stage, out-of-order issue/execution pipeline implemented according to at least one implementation of the disclosure.

FIG. 6 illustrates a block diagram of the micro-architecture for a processing device that includes logic circuits to perform secure memory repartitioning according to one implementation.

FIG. 7 is a block diagram of a computer system according to one implementation.

FIG. 8 is a block diagram of a computer system according to another implementation.

FIG. 9 is a block diagram of a system-on-a-chip according to one implementation.

FIG. 10 illustrates another implementation of a block diagram for a computing system.

FIG. 11 illustrates another implementation of a block diagram for a computing system.

### DETAILED DESCRIPTION

Secure memory repartitioning systems are described. In particular, cache behavior for secure memory repartitioning systems may be provided by the disclosed techniques. Implementations of the disclosure introduce a new attribute for memory transactions and cache lines, as well as new cache behavior in relation to the new attribute, to improve the security and stability of secure memory repartitioning systems implementing memory encryption.

Memory encryption protects the confidentiality of memory-resident data. Memory encryption is primarily designed to protect against passive attacks where an attacker tries to silently observe the data lines as the data move on and off the data lines of the processing device die. Data lines may refer to an electrical line or circuit that carries data. Some processing devices include an encryption module that encrypts sensitive data before the data is stored into a protected region of the memory. On a memory read to the protected region, the data line is decrypted before being fed into the processing device. The encryption and decryption algorithms can be chosen based on the security level requested by the user.

Secure memory repartitioning systems (also referred to as flexible enclave page cache (EPC) systems) implement secure containers, referred to herein as Secure Enclaves (SEs). The SEs are designed to protect third-party secrets from both hardware and software attacks. SE can protect the confidentiality of enclave secrets by ensuring that the enclave secrets are stored encrypted when resident in platform memory. In order to provide complete protection from hardware attacks, SEs provide integrity protection and replay protection. In the absence of such protections, an attacker with physical access to the system can record snapshots of enclave cache lines and replay them at a later point in time. In order to achieve these protections, SE employs a memory encryption engine (MEE), which provides cryptographic mechanisms for encryption, integrity, and replay protection. The MEE is a hardware unit that implements the cryptographic functionality to secure pages when they are in memory. More specifically, the MEE can encrypt any cache line that gets evicted out of the processing device if it belongs to a secure page and the MEE also provides integrity protection and replay-protection for the secure pages. The MEE may reserve a range of platform memory statically at boot time and enforce the cryptographic protections on this range of memory. This secure memory range may is referred to as the Enclave Page Cache (EPC). EPC pages may refer to secure pages that are encrypted and integrity protected by the MEE. Enclave memory requests are satisfied from the EPC.

Conversion instructions may be executed in secure memory repartitioning systems to convert convertible pages to EPC (e.g., also referred to as “secure”) and back to non-EPC. It should be understood that “secure” and “EPC” are used interchangeably herein. The conversion instructions may include a page conversion instruction (referred to as an EMKEPC instruction herein) to convert a non-secure convertible page to an EPC page, and a page allocation instruction (referred to as an EPCALLOC instruction herein) to allocate the converted EPC page in memory for SE use.

Conventional secure memory repartitioning systems enforce rules to provide for encryption of secure memory by the MEE and to provide for access semantics that are followed for any accesses to the secure memory area (i.e., protected region). As such, it should not be possible to receive secure data from outside of enclaves. However, it is possible to have a secure (enclave/EPC) and a non-secure (non-enclave) virtual address mapping to the same physical page frame at the same time. Furthermore, while protected memory is encrypted inside of the main memory, it is in clear format in the cache. As such, in conventional secure memory repartitioning systems, if a non-secure access hits cache lines of the cache and reads these cache lines, it can be a violation of security guarantees for the secure memory repartitioning system by leaking secure data outside of a protected region (e.g., protected region).

Implementations of the disclosure address the above-noted problem by providing a new attribute for memory transactions and cache lines referred to as the Guarded Attribute (GA). The GA is an attribute added to each cache line at all cache levels (e.g., L1, L2, LLC) and to each memory transaction. In one implementation, the GA is an extra bit included with the attributes of the memory transaction or included with the attribute/state data of the TLB and/or cache. The GA indicates that the cache line belongs to an enclave (secure data). Every memory transaction is tagged with the GA and, as such, the GA travels with the memory transaction inside of the memory pipeline. At every cache access, the GA of the access and the GA of the corresponding cache line in the cache can be compared and data (in the cache line) is provided if the two values match. If there is a GA mismatch, then the access is treated as a cache miss. The cache line is then evicted and replaced with data from the memory having a GA value set to the current GA value of the requesting memory transaction.

In implementations of the disclosure, the MEE may process memory accesses that have a GA set (e.g., to 1). Any memory transactions with the GA set (i.e., a secure transaction) are processed by the MEE and regular transactions where the GA is clear (e.g., set to 0) (i.e., non-secure transaction) bypass the MEE. The MEE may observe each access routed to the memory controller to which it is coupled, but the MEE may solely react to those transaction that are secure accesses (e.g., GA set to 1).

Accordingly, implementations of the disclosure improve the performance and security of secure memory repartitioning systems, and specifically of processing devices implementing such systems, by allowing software to use memory conversion instructions without any stability or security issues stemming from accessing data in the cache. With the GA and associated cache behavior, nonsecure memory transactions are not able to receive secure data in clear format via the cache. Performance of the processing device may be further improved by eliminating cache line flushes from being performed by software upon execution of a conversion instruction, thereby eliminating extra processing resources, power, and time that would have been spent on such cache flushes.

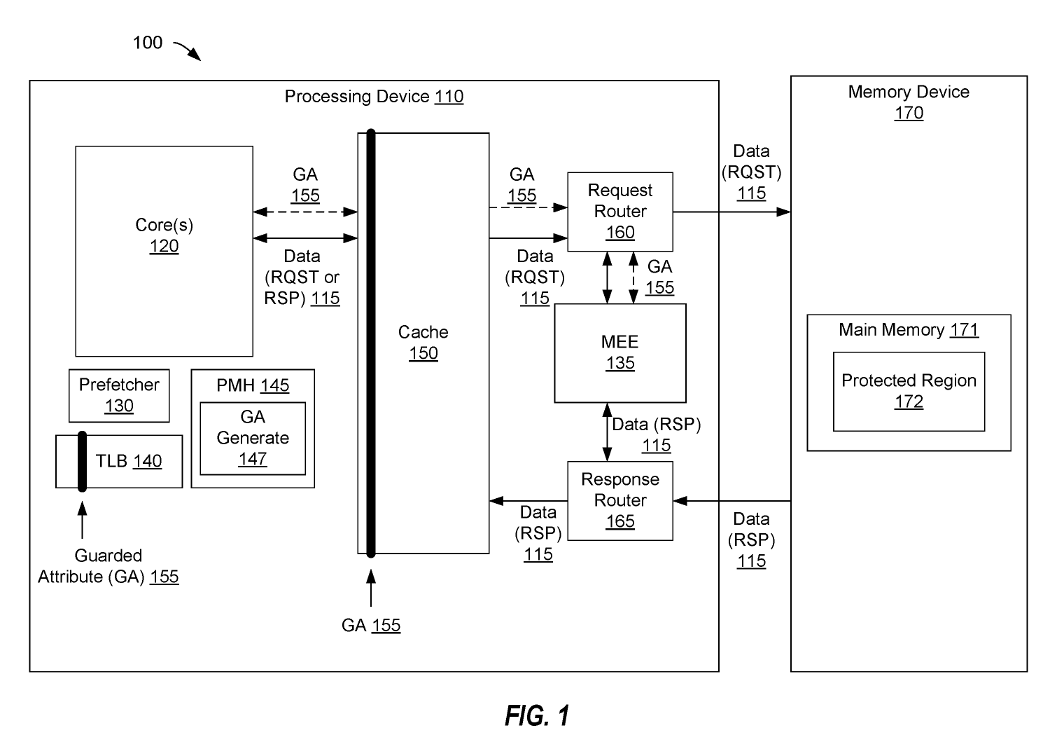

FIG. 1 is a block diagram illustrating a computing system 100 for implementing secure memory according to one implementation. A processing device 110 may include one or more processing cores 120, a translation lookaside buffer (TLB) 140, a page miss handler (PMH) 145, a memory encryption engine (MEE) 135, a cache 150, one or more hardware prefetchers 130 associated with the cache 150, a request router 160, response routers 165, and so forth. Each of the components in the processing device 110 may be communicatively coupled to one another or just a portion of the other components. For example, the processing core 120 may be communicatively coupled to the cache 150 and the MEE 135. Further, the processing device 110 may be coupled to a memory device 170 that includes a protected region 172.

Secure memory ranges (also referred to as the convertible ranges) may be included in the protected region 172 and may be set up at boot time by a basic input-output system (BIOS). In one implementation, the protected region 172 is an enclave (EPC) of the secure memory repartitioning system implemented by computing system 100. The processing device 110 may execute instructions to convert pages in these convertible ranges as guided by software executing on the processing device 110, such as an operating system (OS) or a virtual machine monitor (VMM), as described herein. Also, the memory protections afforded by the MEE 135 may be transparent in the sense that the processing device 110 does not execute any instructions for providing confidentiality, integrity and replay protections. For example, when any cache line belonging to a secure page is evicted, the MEE 135 may automatically provide these protections to that cache line.

The processing device 110 may be used in a system that includes, but is not limited to, a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device. In another implementation, the processing device 110 may be used in a system on a chip (SoC) system.

The computing system 100 is representative of processing systems based on the PENTIUM III™, PENTIUM 4™, Xeon™, Itanium, XScale™ and/or StrongARM™ microprocessors available from Intel Corporation of Santa Clara, Calif., although other systems (including PCs having other microprocessors, engineering workstations, set-top boxes and the like) may also be used. In one implementation, sample system 100 executes a version of the WINDOWS™ operating system available from Microsoft Corporation of Redmond, Wash., although other operating systems (UNIX and Linux for example), embedded software, and/or graphical user interfaces, may also be used. Thus, implementations of disclosure are not limited to any specific combination of hardware circuitry and software.

The one or more processor cores 120 may execute instructions of the system. The processor core 120 includes, but is not limited to, pre-fetch logic to fetch instructions, decode logic to decode the instructions, execution logic to execute instructions and the like. The processing device 110 includes the cache 150 to cache instructions and/or data. The cache 150 includes, but is not limited to: level one (L1), level two (L2), and a last level cache (LLC), or any other configuration of the cache memory within the processing device 110. In another implementation, the computing system 100 includes a component, such as a processing device 110, to employ execution units including logic to perform processes, such as algorithms, for processing data, in accordance with the implementation described herein.

The prefetcher 160 may determine instructions and/or data to prefetch from the memory device 170 in an attempt to improve performance and reduce latency. The prefetcher 160 may prefetch the instructions and/or data based on previously executed instructions and/or previously used data. The hardware prefetcher 160 may operate transparently to fetch streams of data and instructions from the memory device 170 into the cache 150. The prefetcher 160 may handle multiple streams in either the forward or backward direction and the prefetching may occur up to a page boundary.

The request router 160 and response router 165 may be part of a memory controller that performs functions that enable the processing device 110 to access and communicate with the memory device 170 that includes a main memory 171 (e.g., a volatile memory and/or a non-volatile memory). In one implementation, the request router 160 and response router 165 are coupled to the MEE 135, PMH 145, prefetcher 130, and TLB 140. In one implementation, the MEE 135 is located between the cache 150 and the request router 160/response router 165 of the memory controller to perform encryption, decryption and authentication of the data lines moving in and out of the protected region 172 of the memory device 170. In one implementation, the MEE 135 is located on the processor die, while the memory device 170 is located off the processor die.

In an implementation, the MEE 135 may be coupled to the memory controller (request router 160, response router 165). The request router 160 and response router 165 of the memory controller route memory transactions (e.g., read request, write request, prefetch, etc.) depending on the a type of the transaction. If the data is being requested from memory 171, the transaction goes to the request router 160. If the data is being received from memory 171, the transaction goes to the response router 160. A memory access may also be referred to as a memory transaction, a memory request, and/or memory response herein. As illustrated in FIG. 1, the memory access transaction is indicated by both non-dashed arrow lines 115 and dashed arrow lines 155. The portion of the memory access indicated by the non-dashed arrow line 115 may include the request or the response and may include data (e.g., to be saved to memory for a write request or to be returned from memory for a prefetch or read request). The portion of the memory access indicated by the dashed arrow line 155 may include a Guarded Attribute (GA) that is discussed in further detail herein below.

As discussed above, secure memory repartitioning systems (also referred to as flexible enclave page cache (EPC) systems) dictate that secure memory be encrypted by the MEE 135 and that all accesses to the secure memory area (i.e., protected region 172) follow access semantics of the secure memory repartitioning systems. As such, it should not be possible to receive secure data from outside of enclaves. However, it is possible to have a secure (enclave/EPC) and a non-secure (non-enclave) virtual address mapping to the same physical page frame at the same time. Furthermore, while protected memory 172 is encrypted inside of the main memory 171, it is in clear format in the cache 150. As such, if a non-secure access hits cache lines of the cache 150 and reads these cache lines, it can be a violation of security guarantees for the secure memory repartitioning system by leaking secure data outside of a protected region (e.g., protected region 172).

Implementations of the disclosure address the above-noted security issue by providing a new attribute for memory transactions and cache lines referred to as the Guarded Attribute (GA). The GA 155 is an attribute added to each cache line at all cache levels (e.g., L1, L2, LLC) and to each memory transaction. In one implementation, the GA 155 is an extra bit included with the attributes of the memory transaction or included with the attribute/state data of the TLB 140 and/or cache 150. The GA 155 indicates that the cache line belongs to an enclave (secure data). Every memory transaction is tagged with the GA 155 and, as such, the GA 155 travels with the memory transaction inside of the memory pipeline. At every cache 150 access, the GA 155 of the access and the GA 155 of the corresponding cache line in the cache 150 can be compared and data (in the cache line) is provided if the two values match. If there is a GA 155 mismatch, then the access is treated as a cache miss. The cache line is then evicted and replaced with data from the memory 171 having a GA 155 value set to the current GA 155 value of the requesting memory transaction.

In implementations of the disclosure, the MEE 135 may process memory accesses that have a GA 155 set (e.g., to 1). Any memory transactions with the GA 155 set (i.e., a secure transaction) are processed by the MEE 135 and regular transactions where the GA 155 is clear (e.g., set to 0) (i.e., non-secure transaction) bypass the MEE 135. The MEE 135 may observe each access routed to the memory controller (request router 160, response route 165) to which it is coupled, but the MEE 135 may solely react to those transaction that are secure accesses (e.g., GA set to 1).

The secure memory partitioning system implemented by computing system 100 relies on a specific cache behavior that utilizes the attribute of the GA 155. By utilizing the GA 155, cache flushes are not explicitly implemented when memory pages are converted from nonsecure (e.g. REG) to secure (e.g., EPC) or from secure to nonsecure. As discussed above, the GA 144 is added to all cache levels and to all memory transactions.

In one implementation, the GA 155 is included in both the TLB 140 and the cache 150, as well as in each memory transaction. The GA 155 is generated by GA generate circuitry 147 in the PMH 145. The GA generate circuitry 147 may be hardware circuitry that can generate the GA 155 as part of a routine of secure memory tests applied to a memory access request. If the memory access request is for a memory page that does not correspond to an entry in the TLB 140, then the PMH 145 performs a page walk to obtain the address for the page as well as an address translation (virtual to physical) for the memory access request. The PMH 145 additionally performs secure memory access checks to determine whether this is an access to a secure page in the protected region 172, and if so, that all memory access semantics are being obeyed. As part of the secure memory access check, the GA 155 is generated by GA generate circuitry 147. A new TLB entry is then added to the TLB 140 for the memory page, where this new entry includes the generated GA 155.

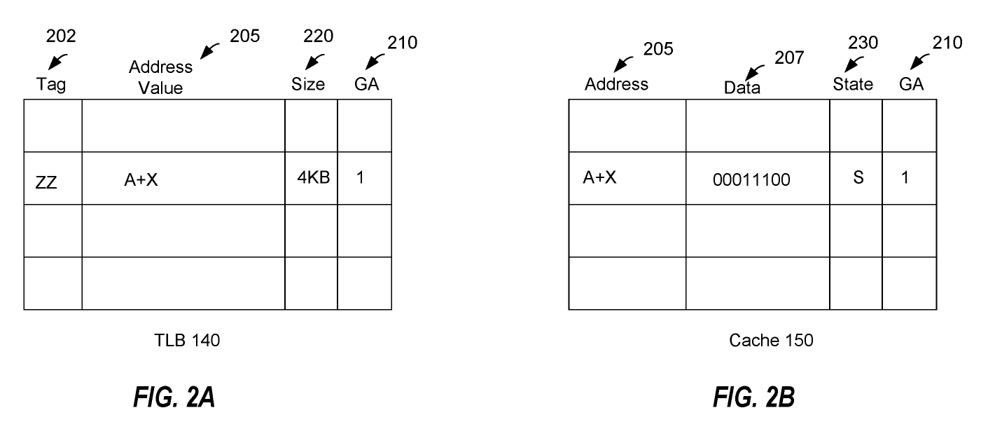

FIG. 2A is a block diagram of a TLB entry including a GA bit according to one implementation. As depicted, the TLB 140 includes multiple entries, where each entry includes a tag 202, an address value 205, a size 220, and the GA 210. Other information may also be included in the TLB entry and implementations of the disclosure are not limited to those depicted and described herein.

In an illustrative example, a write request to a memory page having address A+X may be received at the TLB 140. In the illustrative example, the address of the memory page is not found in the TLB 140. As such, the PMH 145 may begin executing a page walk and determine whether the requested page is secure or non-secure. In one implementation, the PMH 145 may refer to a hierarchical structure of secure state bits to determine whether the requested page is secure or nonsecure. Once the PMH 145 identifies whether the page is secure or nonsecure, the PMH 145 may add the address of the page to the TLB 140. The TLB 140 may include at least the four fields depicted (e.g., tag 202, address 205, size 220, and GA 210). Thus, the PMH 145 may insert the entry for the requested page into the TLB 140 with a tag 202 of the page used to reference the TLB 140, the address 205 of the page (A+X) used as a return value for a TLB lookup operation, the size 220 of the page, and the GA 210 of the page. If the page is determined to be a secure page, then the GA bit is set (e.g., to 1). If the page is determined to be a nonsecure page, then the GA bit is clear (e.g., set to 0).

After the physical address is acquired by the PMH 145 and added to the TLB 140, as described above, the memory transaction continues by attempting to access the physical address. At this point, the memory transaction includes, as part of the memory transaction attributes (e.g., physical address, type of access, etc.), the GA 155 of the TLB entry from which the physical address was obtained. As part of the memory transaction's access attempt, the cache 150 is referenced to attempt to obtain data of the memory page. If the cache 150 does not contain a corresponding cache line entry for the physical address (e.g., cache miss), then main memory 171 is accessed to obtain the data for the memory page. A new cache entry is generated at this point, and the GA of the requesting memory transaction (obtained from the TLB 140) is used to populate the new cache line entry in the cache 150.

FIG. 2B is a block diagram of a cache line entry including a GA bit according to one implementation. As depicted, the cache 150 includes multiple cache line entries, where each entry includes an address 205, data 207, state 230, and the GA 210. In some implementation, a cache line entry may be referred to as a cache line. Other information may also be included in the cache line entry and implementations of the disclosure are not limited to those depicted and described herein.

In an illustrative example, a write request to a memory page having address A+X may be received at the cache 150. The physical address of the memory page is obtained from the TLB 140. The physical address is then used to reference the cache 150. When a cache miss occurs, the requested data is obtained from main memory 171. Once the requested data is obtained, a new cache line entry is created in the cache 150 that includes the address 205 of the page, the obtained data 207 from the main memory 171, the state of the memory page (e.g., shared, modified, etc.), and the GA 210 of the page (as obtained from the current requesting memory transaction).

Referring back to FIG. 1, as discussed above, the memory transaction also includes the GA 155 as part of the attributes of the memory transaction request (e.g., prefetch request, read request, write request, etc.). For example, a memory transaction request may include a physical address being requested (as identified from the TLB 140), a type of access (e.g., read, write, prefetch, etc.), and the GA 155. As discussed above, the GA 155 for the memory transaction may be determined by the PMH 145 and GA generate circuitry 147 when the memory transaction obtains an address translation from the TLB 140 for the memory request.

When the memory transaction references the cache 150 and identifies a cache line that matches the physical address of the memory transaction (e.g., cache hit), then the GA 155 from the memory transaction (may be referred to as the first GA or first GA indictor) and the GA 155 in the cache line (may be referred to as the second GA or second GA indictor) are compared. If there is a match of the GAs 155, then the cache hit is confirmed and the data from the cache line is provided to the memory transaction.

On the other hand, if there is a GA 155 mismatch, then the current cache line entry with its GA is evicted from the cache 150. The particular eviction policy to apply to the cache line depends on whether the cache line is indicated as dirty or not (e.g., identified via a dirty bit included with the cache line). If the cache line is indicated as dirty, then the data 115 of the cache line is written back to the main memory 171. The GA 155 of the cache line is used for purposes of determining whether the MEE 135 encrypts the data 115 during the eviction write back or whether the MEE 135 is bypassed (data written to main memory 171 in clear format). If the GA 155 of the cache line is set, then the data 115 in the cache line is encrypted by the MEE 135 before being saved to the protected region 172. If the GA 155 of the cache line entry is clear, then the data 115 in the cache line is saved to the main memory 171 in a clear format by bypassing the MEE 135. On the other hand, if the cache line is not dirty, then the cache line entry is invalidated without writing the data 115 back to memory.

Once the cache line is evicted, a new cache line is created into the cache 150 using data brought in from the main memory 171 and using the GA 155 of the current memory transaction. This may be referred to as a self-snoop process. The data 115 brought into the cache 150 is further provided to the memory transaction in response to the memory request. The data 115 from the main memory 170 goes through the MEE 135 (for decryption) if the GA 155 of the requesting memory transaction is set. Otherwise (e.g., GA 155 of memory transaction not set), the data 115 bypasses the MEE 135.

As a result of the above, cache misses can occur due to the GA 155 mismatch. If the memory access is a secure access (GA set) and the cache line belongs to a nonsecure (REG) page (GA not set or GA clear), this memory access is treated as a cache miss. When the memory access is a nonsecure access (GA not set) and the cache line belongs to a secure (EPC) page (GA set), this memory access is also treated as a cache miss.

In one implementation, the MEE 135 processes multiple memory read requests in parallel to improve the access latency to the protected region 172. The MEE 132 performs counter-mode encryption which entails the encryption seed to be unique for a data line both temporally and spatially. Spatial uniqueness can be achieved by using the address of the data line to be accessed, while temporal uniqueness can be achieved by using a counter that serves as the version of the data line.

For the following description, the following terminology is used for the memory device 170: The main memory 171 is divided into regions, including one or more protected regions 172 (also referred to herein as secure memory range or MEE region). Each region has multiple sections, an EPC section, which is convertible at page granularity, a hardware reserved section of replay-protection and integrity metadata, which is convertible at section granularity, and another hardware reserved section which is internal to implementation and is not available for conversion. In one implementation, the protected region (MEE region) may be a fixed range or multiple protected regions (MEE regions) may be a set of multiple fixed ranges. In another implementation, the entire memory could be configured as flexible memory, divided into multiple MEE regions. At startup, the entire memory starts as non-secure and the system software converts it as guided by the demand for secure memory on the system. As described herein, the main memory 171 may include multiple secure memory ranges (referred to herein as MEE regions), and may also include non-secure memory ranges.

Implementations are not limited to computer systems. Alternative implementations of the disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one implementation.

One implementation may be described in the context of a single processor desktop or server system, but alternative implementations may be included in a multiprocessor system. System 100 may be an example of a ‘hub’ system architecture. The computer system 100 includes a processing device 110 to process data signals. The processing device 110, as one illustrative example, includes a complex instruction set computer (CISC) microprocessor, a reduced instruction set computing (RISC) microprocessor, a very long instruction word (VLIW) microprocessor, a processing device implementing a combination of instruction sets, or any other processor device, such as a digital signal processor, for example. The processing device 110 is coupled to a processor bus that transmits data signals between the processing device 110 and other components in the system 100, such as memory device 170 storing instruction, data, or any combination thereof. The other components of the system 100 may include a graphics accelerator, a memory controller hub, an I/O controller hub, a wireless transceiver, a Flash BIOS, a network controller, an audio controller, a serial expansion port, an I/O controller, etc. These elements perform their conventional functions that are well known to those familiar with the art.

In one implementation, the processing device 110 includes the internal cache 150. Depending on the architecture, the processing device 110 may have a single internal cache or multiple levels of internal caches. Other implementations include a combination of both internal and external caches depending on the particular implementation and needs. A register file is to store different types of data in various registers including integer registers, floating point registers, vector registers, banked registers, shadow registers, checkpoint registers, status registers, configuration registers, and instruction pointer register.

It should be noted that the execution unit may or may not have a floating point unit. The processing device 110, in one implementation, includes a microcode (ucode) ROM to store microcode, which when executed, is to perform algorithms for certain macroinstructions or handle complex scenarios. Here, microcode is potentially updateable to handle logic bugs/fixes for processing device 110.

Alternate implementations of an execution unit may also be used in micro controllers, embedded processors, graphics devices, DSPs, and other types of logic circuits. System 100 includes the memory device 170. Memory device 170 includes a dynamic random access memory (DRAM) device, a static random access memory (SRAM) device, flash memory device, or other memory device. Memory device 120 stores instructions and/or data represented by data signals that are to be executed by the processing device 110. The processing device 110 is coupled to the memory device 120 via a processor bus. A system logic chip, such as a memory controller hub (MCH) may be coupled to the processor bus and memory device 170. An MCH can provide a high bandwidth memory path to memory device 170 for instruction and data storage and for storage of graphics commands, data and textures. The MCH can be used to direct data signals between the processing device 110, memory device 170, and other components in the system 100 and to bridge the data signals between processor bus, memory device 170, and system I/O, for example. The MCH may be coupled to memory device 170 through a memory interface. In some implementations, the system logic chip can provide a graphics port for coupling to a graphics controller through an Accelerated Graphics Port (AGP) interconnect. The system 100 may also include an I/O controller hub (ICH). The ICH can provide direct connections to some I/O devices via a local I/O bus. The local I/O bus is a high-speed I/O bus for connecting peripherals to the memory device 170, chipset, and processing device 110. Some examples are the audio controller, firmware hub (flash BIOS), wireless transceiver, data storage, legacy I/O controller containing user input and keyboard interfaces, a serial expansion port such as Universal Serial Bus (USB), and a network controller. The data storage device can comprise a hard disk drive, a floppy disk drive, a CD-ROM device, a flash memory device, or other mass storage device.

For another implementation of a system, the instructions executed by the processor core 120 can be used with a system on a chip. One implementation of a system on a chip comprises of a processing device and a memory device. The memory device for one such system is a flash memory. The flash memory can be located on the same die as the processing device and other system components. Additionally, other logic blocks such as a memory controller or graphics controller can also be located on a system on a chip.

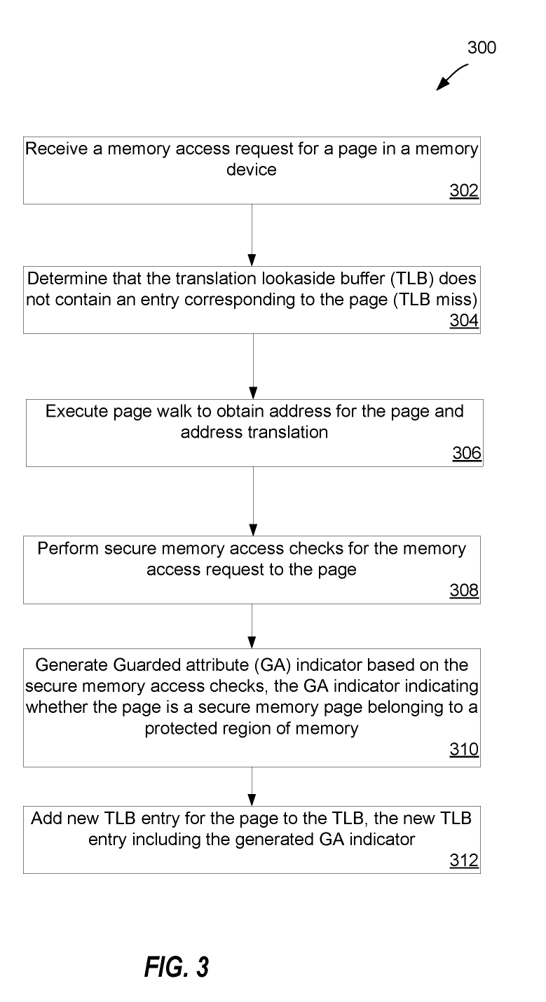

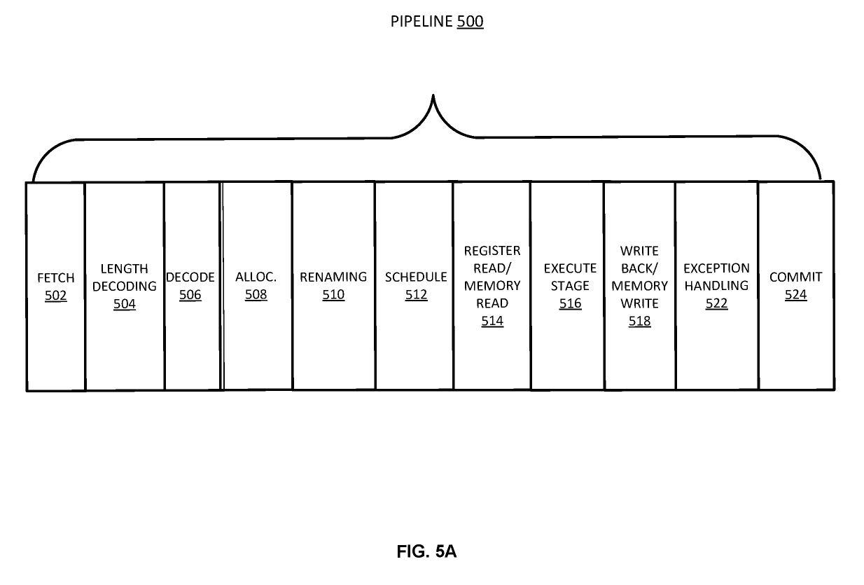

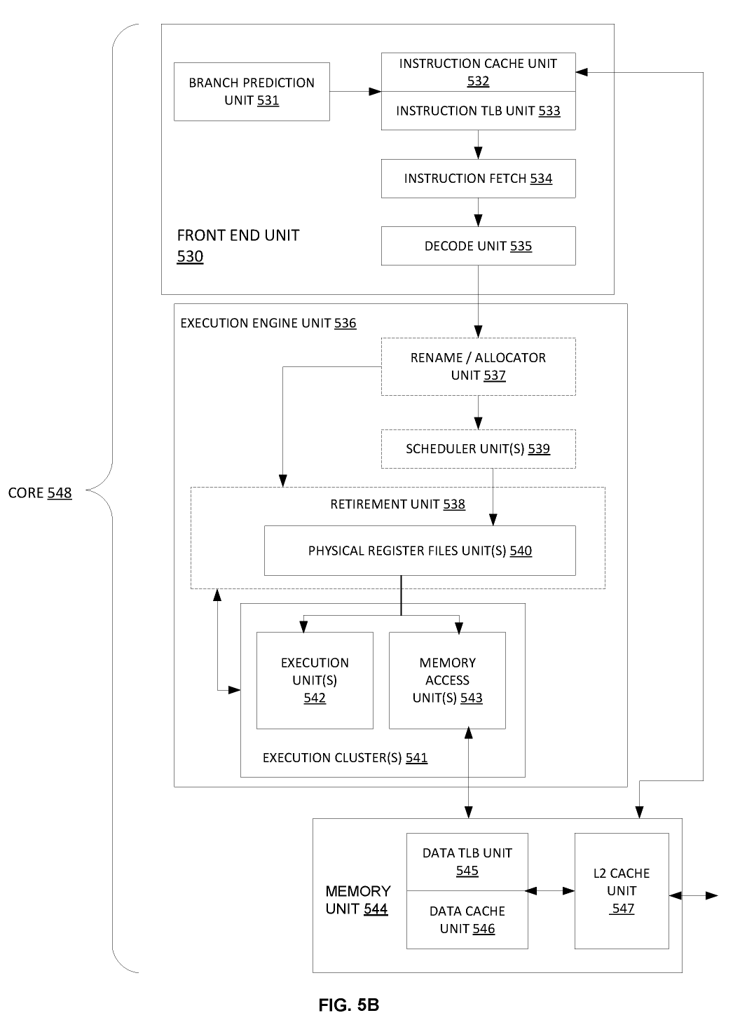

FIG. 3 is a flow diagram of an example method for generating a GA indicator for memory transactions and cache lines in a secure memory repartitioning system according to one implementation. Method 300 may be performed by processing logic that may comprise hardware (e.g., circuitry, dedicated logic, programmable logic, microcode, etc.), software (such as operations being performed by the MCU), firmware or a combination thereof. In one implementation, method 300 is performed by one or more components of the processing device 110 of FIG. 1. In another implementation, the method 300 is performed by any of the processing devices described with respect to FIGS. 5a-11. Alternatively, other components of the computing system 100 (or software executing on the processing device 110) may perform some or all of the operations of the method 300.

Referring to the method 300, at block 302 the processing logic may receive a memory access request for a page in a memory device. Then, at block 304, the processing logic may determine that a TLB does not contain an entry that corresponds to the page (e.g., a TLB miss occurs). At block 306, responsive to the TLB miss of block 304, the processing logic may execute a page walk to obtain an address for the page and an address translation (virtual to physical) for the page.

Subsequently, at block 308, the processing logic may perform secure memory access checks related to the memory access request to the page. In one implementation, the secure memory access checks may whether the page is part of a protected region (enclave) of memory and whether the memory access request may rightly access such a protected region. At block 310, the processing logic may generate a GA indicator based on the secure memory access checks performed at block 308. In one implementation, the GA indicator indicates whether the page is a secure memory page belonging to a protected region of memory or a nonsecure page outside of the protected region. Lastly, at block 312, the processing logic may add a new TLB entry for the page to the TLB. In one implementation, the new TLB entry includes the generated GA indicator.

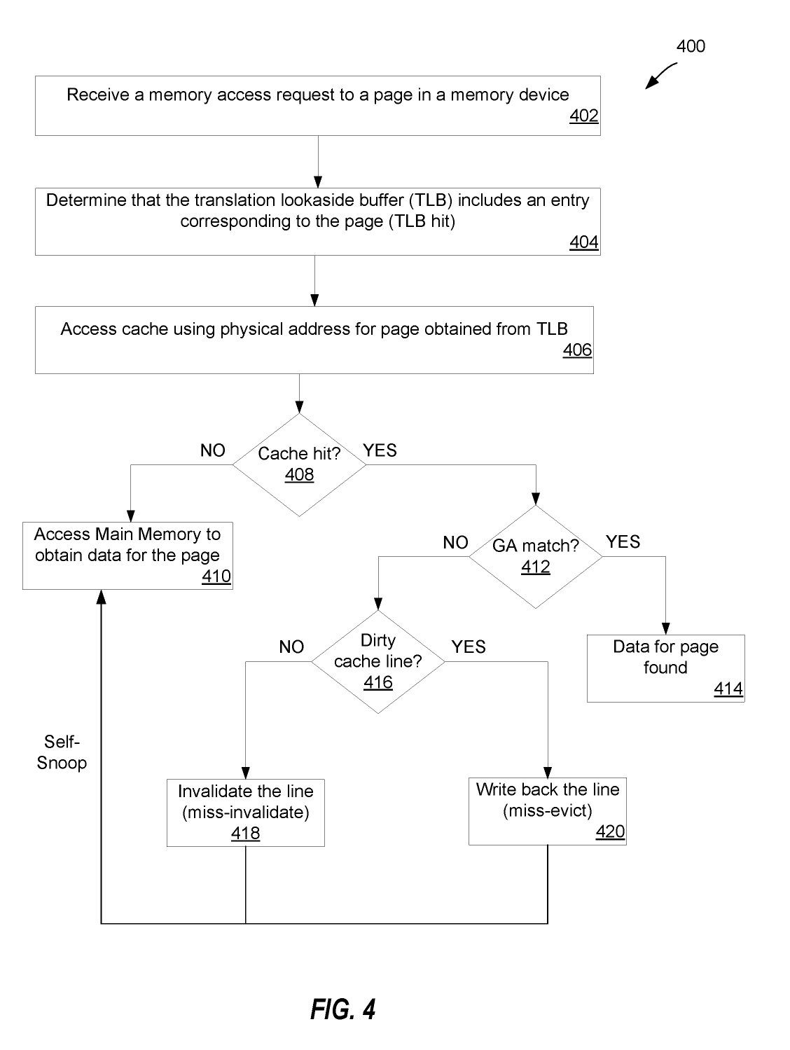

FIG. 4 is a flow diagram of an example method 400 for comparing GA bits during a cache access in a secure memory repartitioning system according to one implementation. Method 400 may be performed by processing logic that may comprise hardware (e.g., circuitry, dedicated logic, programmable logic, microcode, etc.), software (such as operations being performed by the MCU), firmware or a combination thereof. In one implementation, method 400 is performed by one or more components of the processing device 110 of FIG. 1. In another implementation, the method 400 is performed by any of the processing devices described with respect to FIGS. 5a-11. Alternatively, other components of the computing system 100 (or software executing on the processing device 110) may perform some or all of the operations of the method 400.

Referring to the method 400, at block 402, the processing logic may receive a memory access request for a page in a memory device. Then, at block 404, the processing logic may determine that a TLB contain an entry that corresponds to the page (e.g., a TLB hit occurs). At block 406, responsive to the TLB hit of block 404, the processing logic may access the cache using a physical address for the page obtained from the TLB.

At decision block 408, the processing logic may determine whether the cache includes a cache line entry corresponding to the physical address of the page (e.g., cache hit). If there is not a cache hit at decision block 408, the processing logic proceeds to block 410 where main memory is accessed to obtain the data for the page in response to the request. The GA indicator of the memory access request is used to determine whether the data in the memory is decrypted by the MEE prior to being provided in response to the request (i.e., GA indicator is set) or bypasses the MEE to be provided (in response to the request) in the form it was stored in memory (i.e., GA indicator is clear). In addition, this obtained data is used to generate a new cache line in the cache and the new cache line is populated with the GA indicator of the memory access request.

On the other hand, if there is a cache hit at decision block 408, the processing logic proceeds to decision block 412 to determine whether a GA indicator in the memory access request (first GA indicator) matches GA indicator in the cache line (second GA indicator). If a GA indicators match at decision block 412, the processing logic may use the data in the cache line to respond to the memory access request at block 414.

If there is a GA indicator mismatch at block 414, then processing logic treats the cache access as a cache miss and proceeds to decision block 416 to perform a cache eviction process. At decision block 416, processing logic determines whether the cache line is a dirty cache line. In one implementation, a dirty bit in the cache line indicates whether the cache line is dirty or not. If the cache line is not indicated as dirty at decision block 416, then processing logic may invalidate the cache line (e.g., miss-invalidate) at block 418. If the cache line is indicated as direct at decision block 416, then processing logic may write back the cache line to memory at block 420. In one implementation, at block 420, the GA indicator of the cache line is used to determine whether the data in the cache line is encrypted by the MEE prior to being written back to memory (i.e., GA indicator is set) or bypasses the MEE to be written in clear form in the memory (i.e., GA indicator is clear).

Subsequent to both of blocks 418 and 420, the processing logic may perform a self-snoop of the cache by proceeding to block 410. At block 410, the processing logic accesses main memory to obtain the data for the page in response to the request. The GA indicator of the memory access request is used to determine whether the data in the memory is decrypted by the MEE prior to being provided in response to the request (i.e., GA indicator is set) or bypasses the MEE to be provided (in response to the request) in the form it was stored in memory (i.e., GA indicator is clear). In addition, this obtained data is used to generate a new cache line in the cache and the new cache line is populated with the GA indicator of the memory access request.

FIG. 5A is a block diagram illustrating an in-order pipeline and a register re-naming stage, out-of-order issue/execution pipeline of a processor according to at least one implementation of the disclosure. FIG. 5B is a block diagram illustrating an in-order architecture core and a register renaming logic, out-of-order issue/execution logic to be included in a processor according to at least one implementation of the disclosure. The solid lined boxes in FIG. 5A illustrate the in-order pipeline, while the dashed lined boxes illustrates the register renaming, out-of-order issue/execution pipeline. Similarly, the solid lined boxes in FIG. 5B illustrate the in-order architecture logic, while the dashed lined boxes illustrates the register renaming logic and out-of-order issue/execution logic. The pipelines illustrated in FIGS. 5A and 5B may be utilized as part of a processing device to provide cache behavior in secure memory repartitioning system according to implementations of the disclosure, such as processing device 110 of FIG. 1.

In FIG. 5A, a processor pipeline 500 includes a fetch stage 502, a length decode stage 504, a decode stage 506, an allocation stage 508, a renaming stage 510, a scheduling (also known as a dispatch or issue) schedule stage 512, a register read/memory read stage 514, an execute stage 516, a write back/memory write stage 518, an exception handling stage 522, and a commit stage 524. In some implementations, the stages are provided in a different order and different stages may be considered in-order and out-of-order.

In FIG. 5B, arrows denote a coupling between two or more units and the direction of the arrow indicates a direction of data flow between those units. FIG. 5B shows processor core (core) 548 including a front end unit 530 coupled to an execution engine unit 536, and both are coupled to a memory unit 544.

The core 548 may be a reduced instruction set computing (RISC) core, a complex instruction set computing (CISC) core, a very long instruction word (VLIW) core, or a hybrid or alternative core type. As yet another option, the core 548 may be a special-purpose core, such as, for example, a network or communication core, compression engine, graphics core, or the like.

The front end unit 530 includes a branch prediction unit 531 coupled to an instruction cache unit 532, which is coupled to an instruction translation lookaside buffer (TLB) 533, which is coupled to an instruction fetch unit 534, which is coupled to a decode unit 535. The decode unit or decoder may decode instructions, and generate as an output one or more micro-operations, micro-code entry points, microinstructions, other instructions, or other control signals, which are decoded from, or which otherwise reflect, or are derived from, the original instructions. The decoder may be implemented using various different mechanisms. Examples of suitable mechanisms include, but are not limited to, look-up tables, hardware implementations, programmable logic arrays (PLAs), microcode read only memories (ROMs), etc. The instruction cache unit 532 is further coupled to a level 2 (L2) cache unit 547 in the memory unit 544. The decode unit 535 is coupled to a rename/allocator unit 537 in the execution engine unit 536.

The execution engine unit 536 includes the rename/allocator unit 537 coupled to a retirement unit 538 and a set of one or more scheduler unit(s) 539. The scheduler unit(s) 539 represents any number of different schedulers, including reservations stations, central instruction window, etc. The scheduler unit(s) 539 is coupled to the physical register file(s) unit(s) 540. Each of the physical register file(s) units 540 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 540 is overlapped by the retirement unit 538 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.).

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 538 and the physical register file(s) unit(s) 540 are coupled to the execution cluster(s) 541. The execution cluster(s) 541 includes a set of one or more execution units 542 and a set of one or more memory access units 543. The execution units 542 may perform various operations (e.g., shifts, addition, subtraction, multiplication) and on various types of data (e.g., scalar floating point, packed integer, packed floating point, vector integer, vector floating point).

While some implementations may include a number of execution units dedicated to specific functions or sets of functions, other implementations may include one execution unit or multiple execution units that all perform all functions. The scheduler unit(s) 539, physical register file(s) unit(s) 540, and execution cluster(s) 541 are shown as being possibly plural because certain implementations create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain implementations are implemented in which the execution cluster of this pipeline has the memory access unit(s) 543). It should also be understood that where separate pipelines are used, one or more of these pipelines may be out-of-order issue/execution and the rest in-order.

The set of memory access units 543 is coupled to the memory unit 544, which includes a data TLB unit 545 coupled to a data cache unit 546 coupled to a level 2 (L2) cache unit 547. In one exemplary implementation, the memory access units 543 may include a load unit, a store address unit, and a store data unit, each of which is coupled to the data TLB unit 545 in the memory unit 544. The L2 cache unit 547 is coupled to one or more other levels of cache and eventually to a main memory.

By way of example, the exemplary register renaming, out-of-order issue/execution core architecture may implement the pipeline 500 of FIG. 5A as follows: 1) the instruction fetch 38 performs the fetch and length decoding stages 502 and 504 respectively; 2) the decode unit 535 performs the decode stage 506; 3) the rename/allocator unit 537 performs the allocation stage 508 and renaming stage 510; 4) the scheduler unit(s) 539 performs the schedule stage 512; 5) the physical register file(s) unit(s) 540 and the memory unit 544 perform the register read/memory read stage 514; the execution cluster 541 perform the execute stage 516; 6) the memory unit 544 and the physical register file(s) unit(s) 540 perform the write back/memory write stage 518; 7) various units may be involved in the exception handling stage 522) the retirement unit 538 and the physical register file(s) unit(s) 540 perform the commit stage 524.

The core 548 may support one or more instructions sets (e.g., the x86 instruction set (with some extensions that have been added with newer versions); the MIPS instruction set of MIPS Technologies of Sunnyvale, Calif.; the ARM instruction set (with additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in-order architecture. While the illustrated implementation of the processor also includes a separate instruction and data cache units 532/546 and a shared L2 cache unit 547, alternative implementations may have a single internal cache for both instructions and data, such as, for example, a Level 1 (L1) internal cache, or multiple levels of internal cache. In some implementations, the system may include a combination of an internal cache and an external cache that is external to the core and/or the processor. Alternatively, all of the cache may be external to the core and/or the processor.

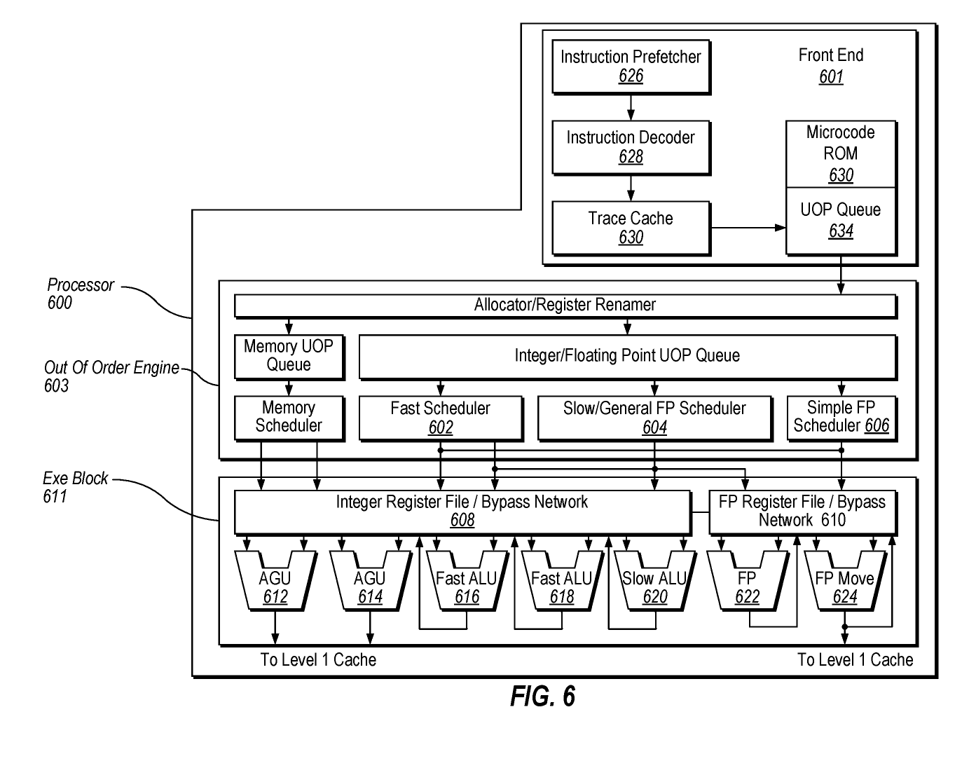

FIG. 6 illustrates a block diagram of the micro-architecture for a processing device 600 that includes logic circuits to perform cache behavior in secure memory repartitioning systems according to one implementation. In some implementations, an instruction can be implemented to operate on data elements having sizes of byte, word, doubleword, quadword, etc., as well as datatypes, such as single and double precision integer and floating point datatypes. In one implementation the in-order front end 601 is the part of the processing device 600 that fetches instructions to be executed and prepares them to be used later in the processing device pipeline.

The front end 601 may include several units. In one implementation, the instruction prefetcher 616 fetches instructions from memory and feeds them to an instruction decoder 618 which in turn decodes or interprets them. For example, in one implementation, the decoder decodes a received instruction into one or more operations called “micro-instructions” or “micro-operations” (also called micro op or uops) that the machine can execute. In other implementations, the decoder parses the instruction into an opcode and corresponding data and control fields that are used by the micro-architecture to perform operations in accordance with one implementation. In one implementation, the trace cache 630 takes decoded uops and assembles them into program ordered sequences or traces in the uop queue 634 for execution. When the trace cache 630 encounters a complex instruction, the microcode ROM 632 provides the uops needed to complete the operation.

Some instructions are converted into a single micro-op, whereas others need several micro-ops to complete the full operation. In one implementation, if more than four micro-ops are needed to complete an instruction, the decoder 618 accesses the microcode ROM 632 to do the instruction. For one implementation, an instruction can be decoded into a small number of micro ops for processing at the instruction decoder 618. In another implementation, an instruction can be stored within the microcode ROM 632 should a number of micro-ops be needed to accomplish the operation. The trace cache 630 refers to an entry point programmable logic array (PLA) to determine a correct micro-instruction pointer for reading the micro-code sequences to complete one or more instructions in accordance with one implementation from the micro-code ROM 632. After the microcode ROM 632 finishes sequencing micro-ops for an instruction, the front end 601 of the machine resumes fetching micro-ops from the trace cache 630.

The out-of-order execution engine 603 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 602, slow/general floating point scheduler 604, and simple floating point scheduler 606. The uop schedulers 602, 604, 606, determine when a uop is ready to execute based on the readiness of their dependent input register operand sources and the availability of the execution resources the uops need to complete their operation. The fast scheduler 602 of one implementation can schedule on each half of the main clock cycle while the other schedulers can only schedule once per main processing device clock cycle. The schedulers arbitrate for the dispatch ports to schedule uops for execution.

Register files 608, 610, sit between the schedulers 602, 604, 606, and the execution units 612, 614, 616, 618, 610, 612, 614 in the execution block 611. There is a separate register file 608, 610, for integer and floating point operations, respectively. Each register file 608, 610, of one implementation also includes a bypass network that can bypass or forward just completed results that have not yet been written into the register file to new dependent uops. The integer register file 608 and the floating point register file 610 are also capable of communicating data with the other. For one implementation, the integer register file 608 is split into two separate register files, one register file for the low order 32 bits of data and a second register file for the high order 32 bits of data. The floating point register file 610 of one implementation has 128 bit wide entries because floating point instructions typically have operands from 64 to 128 bits in width.

The execution block 611 contains the execution units 612, 614, 616, 618, 610, 612, 614, where the instructions are actually executed. This section includes the register files 608, 610, that store the integer and floating point data operand values that the micro-instructions need to execute. The processing device 600 of one implementation is comprised of a number of execution units: address generation unit (AGU) 612, AGU 614, fast ALU 616, fast ALU 618, slow ALU 610, floating point ALU 612, floating point move unit 614. For one implementation, the floating point execution blocks 612, 614, execute floating point, MMX, SIMD, and SSE, or other operations. The floating point ALU 612 of one implementation includes a 64 bit by 64 bit floating point divider to execute divide, square root, and remainder micro-ops. For implementations of the disclosure, instructions involving a floating point value may be handled with the floating point hardware.

In one implementation, the ALU operations go to the high-speed ALU execution units 616, 618. The fast ALUs 616, 618, of one implementation can execute fast operations with an effective latency of half a clock cycle. For one implementation, most complex integer operations go to the slow ALU 610 as the slow ALU 610 includes integer execution hardware for long latency type of operations, such as a multiplier, shifts, flag logic, and branch processing. Memory load/store operations are executed by the AGUs 612, 614. For one implementation, the integer ALUs 616, 618, 610, are described in the context of performing integer operations on 64 bit data operands. In alternative implementations, the ALUs 616, 618, 610, can be implemented to support a variety of data bits including 16, 32, 128, 256, etc. Similarly, the floating point units 612, 614, can be implemented to support a range of operands having bits of various widths. For one implementation, the floating point units 612, 614, can operate on 128 bits wide packed data operands in conjunction with SIMD and multimedia instructions.

In one implementation, the uops schedulers 602, 604, 606, dispatch dependent operations before the parent load has finished executing. As uops are speculatively scheduled and executed in processing device 600, the processing device 600 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one implementation of a processing device are also designed to catch instruction sequences for text string comparison operations.

The term “registers” may refer to the on-board processing device storage locations that are used as part of instructions to identify operands. In other words, registers may be those that are usable from the outside of the processing device (from a programmer's perspective). However, the registers of an implementation should not be limited in meaning to a particular type of circuit. Rather, a register of an implementation is capable of storing and providing data, and performing the functions described herein. The registers described herein can be implemented by circuitry within a processing device using any number of different techniques, such as dedicated physical registers, dynamically allocated physical registers using register renaming, combinations of dedicated and dynamically allocated physical registers, etc. In one implementation, integer registers store thirty-two bit integer data. A register file of one implementation also contains eight multimedia SIMD registers for packed data.

For the discussions herein, the registers are understood to be data registers designed to hold packed data, such as 64 bits wide MMX™ registers (also referred to as ‘mm’ registers in some instances) in microprocessing devices enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one implementation, in storing packed data and integer data, the registers do not need to differentiate between the two data types. In one implementation, integer and floating point are either contained in the same register file or different register files. Furthermore, in one implementation, floating point and integer data may be stored in different registers or the same registers.

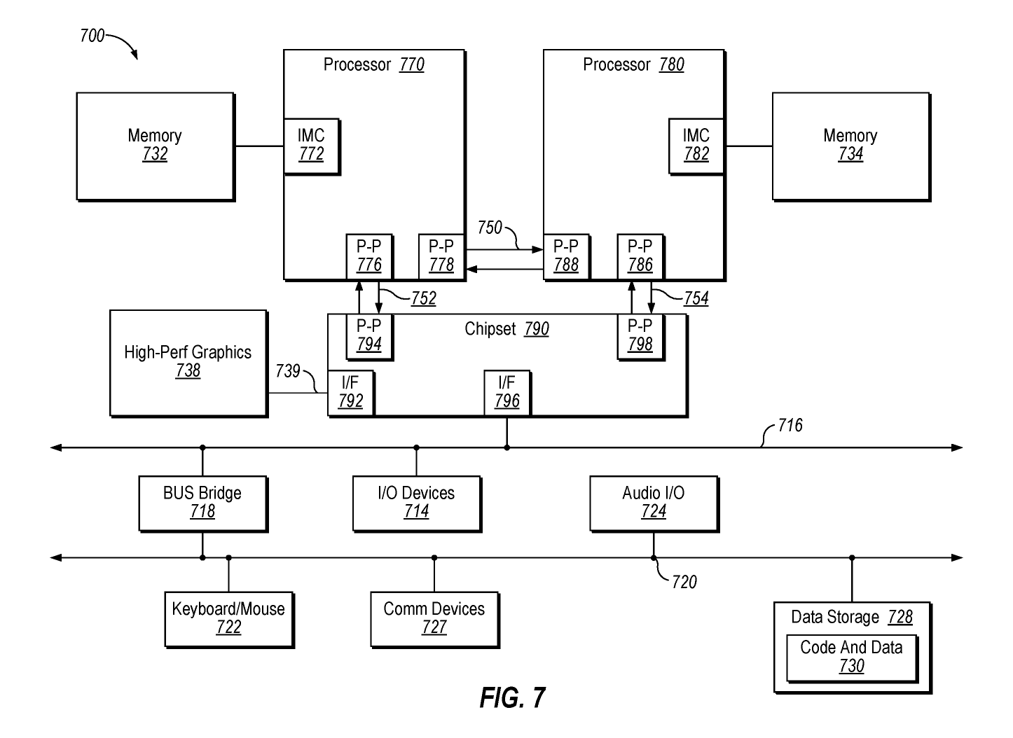

Implementations may be implemented in many different system types. Referring now to FIG. 7, shown is a block diagram of a multiprocessing device system 700 in accordance with an implementation. As shown in FIG. 7, multiprocessing device system 700 is a point-to-point interconnect system, and includes a first processing device 770 and a second processing device 780 coupled via a point-to-point interconnect 750. As shown in FIG. 7, each of processing devices 770 and 780 may be multicore processing devices, including first and second processing device cores (not shown), although potentially many more cores may be present in the processing devices. The processing devices each may include hybrid write mode logics in accordance with an implementation of the present. The implementations of the cache behavior for secure memory repartitioning systems can be implemented in the processing device 770, processing device 780, or both.

While shown with two processing devices 770, 780, it is to be understood that the scope of the disclosure is not so limited. In other implementations, one or more additional processing devices may be present in a given processing device.

Processing devices 770 and 780 are shown including integrated memory controller units 772 and 782, respectively. Processing device 770 also includes as part of its bus controller units point-to-point (P-P) interfaces 776 and 778; similarly, second processing device 780 includes P-P interfaces 786 and 788. Processing devices 770, 780 may exchange information via a point-to-point (P-P) interface 750 using P-P interface circuits 778, 788. As shown in FIG. 7, IMCs 772 and 782 couple the processing devices to respective memories, namely a memory 732 and a memory 734, which may be portions of main memory locally attached to the respective processing devices.

Processing devices 770, 780 may each exchange information with a chipset 790 via individual P-P interfaces 752, 754 using point to point interface circuits 776, 794, 786, 798. Chipset 790 may also exchange information with a high-performance graphics circuit 738 via a high-performance graphics interface 739.

A shared cache (not shown) may be included in either processing device or outside of both processing devices, yet connected with the processing devices via P-P interconnect, such that either or both processing devices' local cache information may be stored in the shared cache if a processing device is placed into a low power mode.

Chipset 790 may be coupled to a first bus 716 via an interface 796. In one implementation, first bus 716 may be a Peripheral Component Interconnect (PCI) bus, or a bus such as a PCI Express bus or another third generation I/O interconnect bus, although the scope of the disclosure is not so limited.

As shown in FIG. 7, various I/O devices 714 may be coupled to first bus 716, along with a bus bridge 718 which couples first bus 716 to a second bus 720. In one implementation, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one implementation. Further, an audio I/O 724 may be coupled to second bus 720. Note that other architectures are possible. For example, instead of the point-to-point architecture of FIG. 7, a system may implement a multi-drop bus or other such architecture.

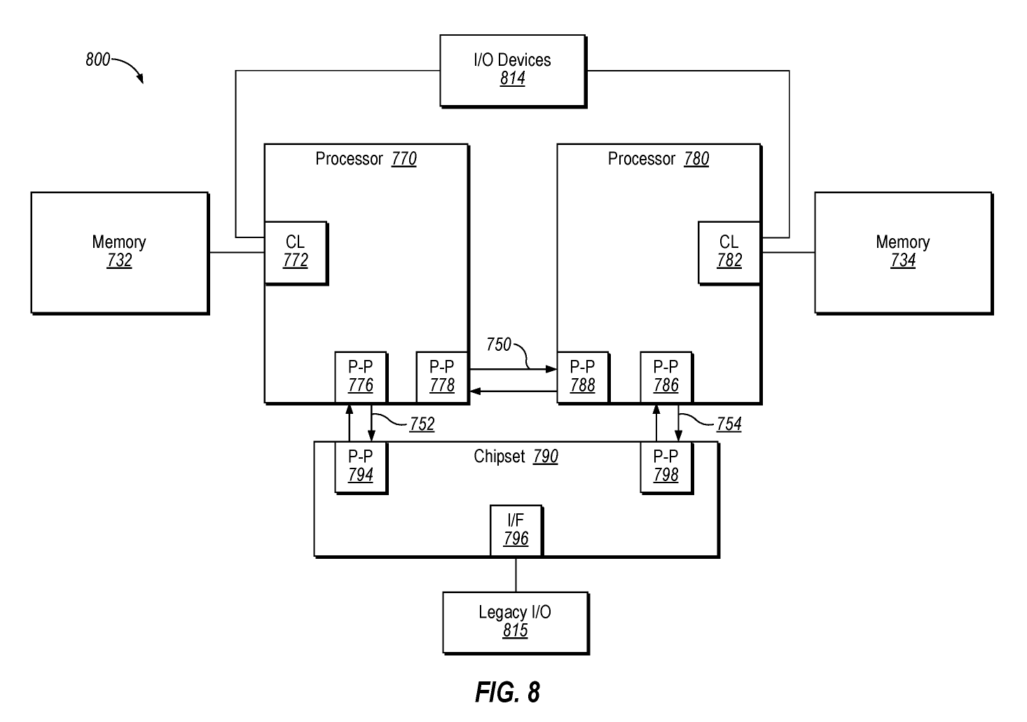

Referring now to FIG. 8, shown is a block diagram of a third system 800 in accordance with an implementation of the disclosure. Like elements in FIGS. 7 and 8 bear like reference numerals and certain aspects of FIG. 7 have been omitted from FIG. 8 in order to avoid obscuring other aspects of FIG. 8.

FIG. 8 illustrates that the processing devices 770, 780 may include integrated memory and I/O control logic (“CL”) 772 and 782, respectively. For at least one implementation, the CL 772, 782 may include integrated memory controller units such as described herein. In addition. CL 772, 782 may also include I/O control logic. FIG. 7 illustrates that the memories 732, 734 are coupled to the CL 772, 782, and that I/O devices 814 are also coupled to the control logic 772, 782. Legacy I/O devices 815 are coupled to the chipset 790. The implementations of the secure memory repartitioning technologies can be implemented in processing device 770, processing device 780, or both.

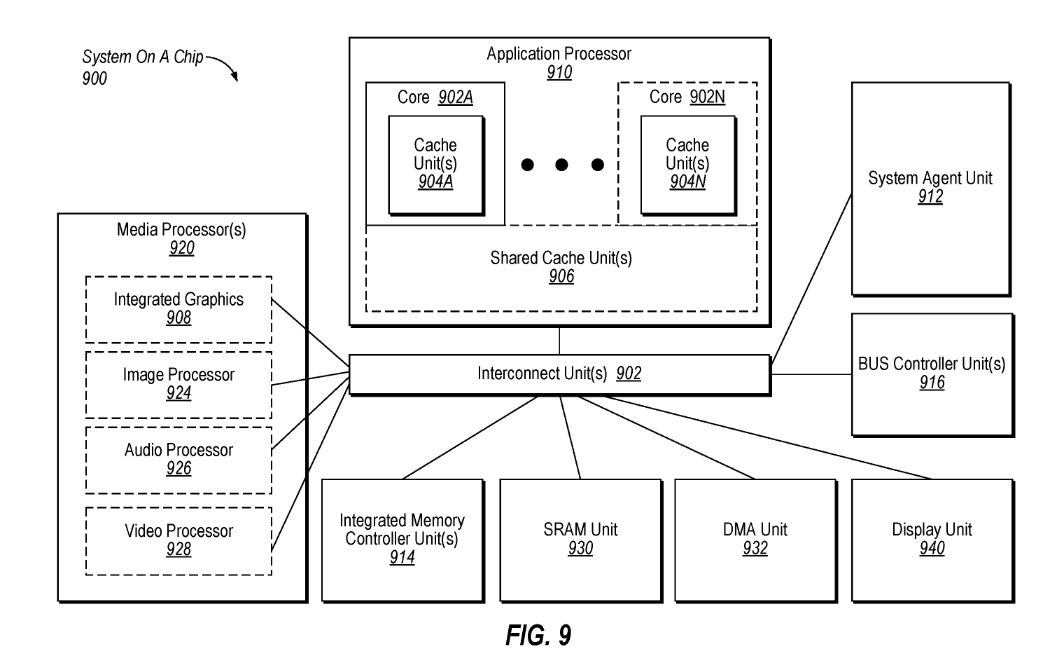

FIG. 9 is an example system on a chip (SoC) that may include one or more of the cores 902. Other system designs and configurations known in the arts for laptops, desktops, handheld PCs, personal digital assistants, engineering workstations, servers, network devices, network hubs, switches, embedded processing devices, digital signal processing devices (DSPs), graphics devices, video game devices, set-top boxes, micro controllers, cell phones, portable media players, hand held devices, and various other electronic devices, are also suitable. In general, a huge variety of systems or electronic devices capable of incorporating a processing device and/or other execution logic as disclosed herein are generally suitable.

Referring now to FIG. 9, shown is a block diagram of a SoC 900 in accordance with an implementation of the disclosure. Also, dashed lined boxes are features on more advanced SoCs. In FIG. 9, an interconnect unit(s) 902 is coupled to: an application processing device 910 which includes a set of one or more cores 902A-N and shared cache unit(s) 906; a system agent unit 912; a bus controller unit(s) 916; an integrated memory controller unit(s) 914; a set or one or more media processing devices 920 which may include integrated graphics logic 908, an image processing device 924 for providing still and/or video camera functionality, an audio processing device 926 for providing hardware audio acceleration, and a video processing device 928 for providing video encode/decode acceleration; a static random access memory (SRAM) unit 930; a direct memory access (DMA) unit 932; and a display unit 940 for coupling to one or more external displays. The implementations of the cache behavior for secure memory repartitioning systems can be implemented in SoC 900.

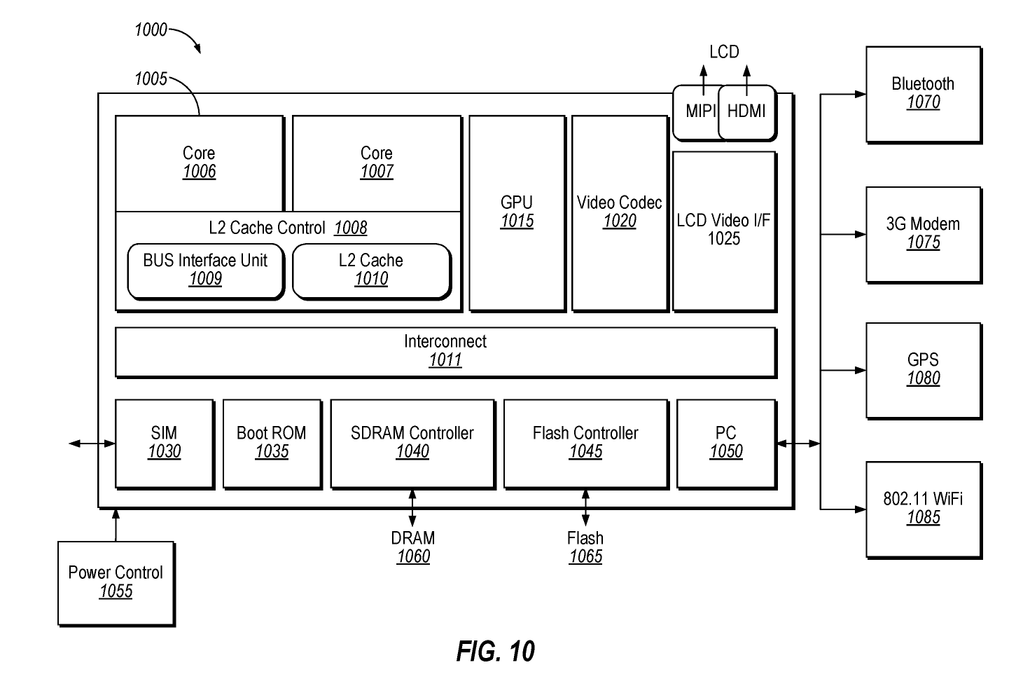

Turning next to FIG. 10, an implementation of an SoC design in accordance with implementations of the disclosure is depicted. As an illustrative example, SoC 1000 is included in user equipment (UE). In one implementation, UE refers to any device to be used by an end-user to communicate, such as a hand-held phone, smartphone, tablet, ultra-thin notebook, notebook with broadband adapter, or any other similar communication device. A UE may connect to a base station or node, which can correspond in nature to a mobile station (MS) in a GSM network. The implementations of the cache behavior for secure memory repartitioning systems can be implemented in SoC 1000.

Here, SoC 1020 includes 2 cores—1006 and 1007. Similar to the discussion above, cores 1006 and 1007 may conform to an Instruction Set Architecture, such as a processing device having the Intel® Architecture Core™, an Advanced Micro Devices, Inc. (AMD) processing device, a MIPS-based processing device, an ARM-based processing device design, or a customer thereof, as well as their licensees or adopters. Cores 1006 and 1007 are coupled to cache control 1008 that is associated with bus interface unit 1009 and L2 cache 1010 to communicate with other parts of system 1000. Interconnect 1011 includes an on-chip interconnect, such as an IOSF, AMBA, or other interconnects discussed above, which can implement one or more aspects of the described disclosure.

Interconnect 1011 provides communication channels to the other components, such as a Subscriber Identity Module (SIM) 1030 to interface with a SIM card, a boot ROM 1035 to hold boot code for execution by cores 1006 and 1007 to initialize and boot SoC 1000, a SDRAM controller 1040 to interface with external memory (e.g. DRAM 1060), a flash controller 1045 to interface with non-volatile memory (e.g. Flash 1065), a peripheral control 1050 (e.g. Serial Peripheral Interface) to interface with peripherals, video codecs 1020 and Video interface 1025 to display and receive input (e.g. touch enabled input), GPU 1015 to perform graphics related computations, etc. Any of these interfaces may incorporate aspects of the implementations described herein.

In addition, the system illustrates peripherals for communication, such as a Bluetooth module 1070, 3G modem 1075, GPS 1080, and Wi-Fi 1085. Note as stated above, a UE includes a radio for communication. As a result, these peripheral communication modules may not all be included. However, in a UE some form of a radio for external communication should be included.

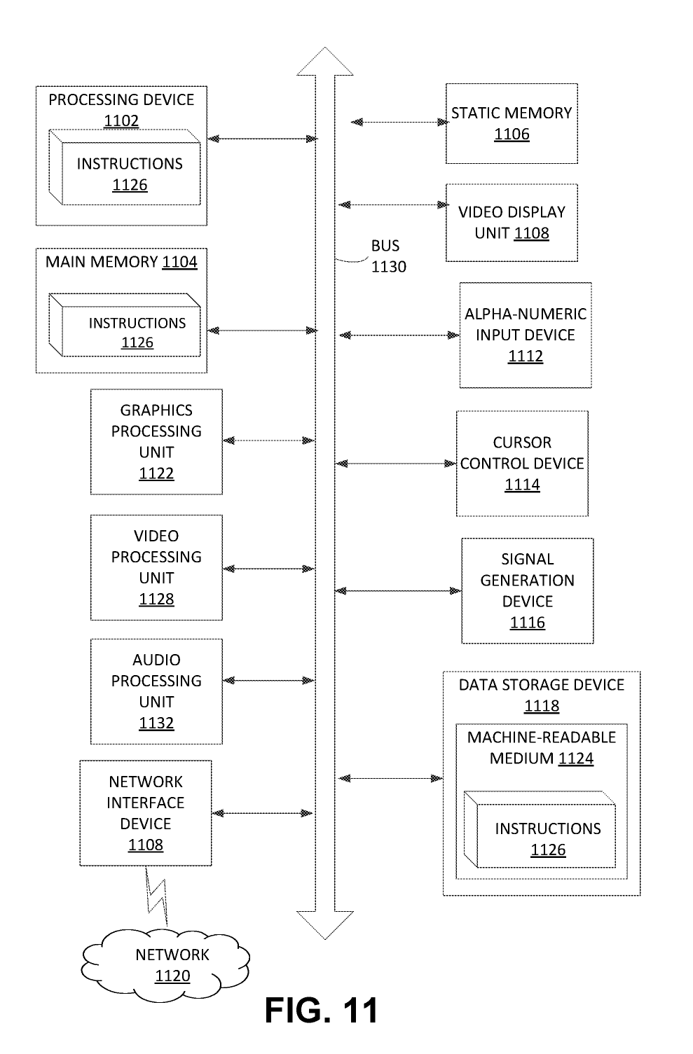

FIG. 11 illustrates a diagrammatic representation of a machine in the example form of a computing system 1100 within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. The implementations of the converting pages and sections can be implemented in computing system 1100.

The computing system 1100 includes a processing device 1102, main memory 1104 (e.g., read-only memory (ROM), flash memory, dynamic random access memory (DRAM) (such as synchronous DRAM (SDRAM) or DRAM (RDRAM), etc.), a static memory 1106 (e.g., flash memory, static random access memory (SRAM), etc.), and a data storage device 1118, which communicate with each other via a bus 1130.

Processing device 1102 represents one or more general-purpose processing devices such as a microprocessing device, central processing unit, or the like. More particularly, the processing device may be complex instruction set computing (CISC) microprocessing device, reduced instruction set computer (RISC) microprocessing device, very long instruction word (VLIW) microprocessing device, or processing device implementing other instruction sets, or processing devices implementing a combination of instruction sets. Processing device 1102 may also be one or more special-purpose processing devices such as an application specific integrated circuit (ASIC), a field programmable gate array (FPGA), a digital signal processing device (DSP), network processing device, or the like. In one implementation, processing device 1102 may include one or processing device cores. The processing device 1102 is configured to execute the processing logic 1126 for performing the operations discussed herein. In one implementation, processing device 1102 can be part of the computing system 100 of FIG. 1. Alternatively, the computing system 1100 can include other components as described herein. It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

The computing system 1100 may further include a network interface device 1108 communicably coupled to a network 1120. The computing system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), a signal generation device 1116 (e.g., a speaker), or other peripheral devices. Furthermore, computing system 1100 may include a graphics processing unit 1122, a video processing unit 1128 and an audio processing unit 1132. In another implementation, the computing system 1100 may include a chipset (not illustrated), which refers to a group of integrated circuits, or chips, that are designed to work with the processing device 1102 and controls communications between the processing device 1102 and external devices. For example, the chipset may be a set of chips on a motherboard that links the processing device 1102 to very high-speed devices, such as main memory 1104 and graphic controllers, as well as linking the processing device 1102 to lower-speed peripheral buses of peripherals, such as USB, PCI or ISA buses.

The data storage device 1118 may include a computer-readable storage medium 1124 on which is stored software 1126 embodying any one or more of the methodologies of functions described herein. The software 1126 may also reside, completely or at least partially, within the main memory 1104 as instructions 1126 and/or within the processing device 1102 as processing logic 1126 during execution thereof by the computing system 1100; the main memory 1104 and the processing device 1102 also constituting computer-readable storage media.

The computer-readable storage medium 1124 may also be used to store instructions 1126 utilizing the processing device 1102, such as described with respect to FIG. 1, and/or a software library containing methods that call the above applications. While the computer-readable storage medium 1124 is shown in an example implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instruction for execution by the machine and that cause the machine to perform any one or more of the methodologies of the implementations. The term “computer-readable storage medium” shall accordingly be taken to include, but not be limited to, solid-state memories, and optical and magnetic media.

The following examples pertain to further implementations. Example 1 is a processing device for implementing cache behavior for secure memory repartitioning systems. Further to Example 1, the processing device comprises a processing core and a memory controller coupled between the processor core and a memory device, where the memory device comprises a memory range comprising a section of convertible pages that are convertible to secure pages or non-secure pages. In Example 1, the processor core is to receive a memory access request to a page in the memory device, the memory access request comprising a first guarded attribute (GA) indicator indicating whether the page is a secure page belonging to an enclave, determine whether the first GA indicator matches a second GA indicator in a cache line entry corresponding to the page, the cache line entry comprised in a cache, responsive to a determination that the first GA indicator matches the second GA indicator, return first data in the cache line entry for the page, and responsive to a determination that the first GA indicator does not match the second GA indicator, apply an eviction policy to the cache line entry based on whether the cache line is indicated as a dirty cache line and accessing second data in the memory device for the page.

In Example 2, the subject matter of Example 1 can optionally include wherein the processing device to apply the eviction policy further comprises the processing device to, responsive to the cache line entry being indicated as a dirty cache line, write back the first data in the cache line entry to the memory device and performing a self-snoop to read the second data in the memory device for the page and add the second data to the cache. In Example 3, the subject matter of any one of Examples 1-2 can optionally include wherein responsive to the GA indicator being set, the first data is encrypted by a memory encryption engine (MEE) prior to writing the first data back to the memory device. In Example 4, the subject matter of any one of Examples 1-3 can optionally include wherein responsive to the GA indicator being clear, the first data bypasses a memory encryption engine (MEE) when writing the first data back to the memory device.

In Example 5, the subject matter of any one of Examples 1-4 can optionally include wherein the processing device to apply the eviction policy further comprises the processing device to, responsive to the cache line entry being indicated as a clean cache line, invalidate the first data in the cache line entry and performing a self-snoop to read the second data in the memory device for the page and add the second data to the cache. In Example 6, the subject matter of any one of Examples 1-5 can optionally include wherein the second GA indicator is separate from a tag corresponding to an address for the page in the cache line entry, the tag used for lookup operations in the cache. In Example 7, the subject matter of any one of Examples 1-6 can optionally include wherein the second GA indicator comprises a bit in the cache line entry.

In Example 8, the subject matter of any one of Examples 1-7 can optionally include wherein the first GA indicator is obtained from a translation lookaside buffer (TLB) entry for an address of the page. In Example 9, the subject matter of any one of Examples 1-8 can optionally include wherein the first GA indicator comprises a bit in the TLB entry. In Example 10, the subject matter of any one of Examples 1-9 can optionally include wherein the processing device is further to, responsive to failure to locate the cache line entry for the page in the cache, access the memory device to obtain the second data for the page.

In Example 11, the subject matter of any one of Examples 1-10 can optionally include wherein the processing device further comprises a page miss handler (PMH) to, responsive to determining that a translation lookaside buffer (TLB) of the processing device does not comprise a TLB entry corresponding to the page and prior to determining whether the first GA indicator matches the second GA indicator: perform a page walk to obtain an address for the page, perform secure memory access checks for the memory access request to the page, generate the first GA indicator based on the secure access memory checks, and add a new TLB entry to the TLB, the new TLB entry comprising the first GA indicator. All optional features of the apparatus described above may also be implemented with respect to the method or process described herein.

Example 12 is a method for implementing cache behavior for secure memory repartitioning systems comprising receiving, by a processing device, a memory access request to a page in a memory device communicably coupled to the processing device, the memory access request comprising a first guarded attribute (GA) indicator indicating whether the page is a secure page belonging to an enclave, determining, by the processing device, whether the first GA indicator matches a second GA indicator in a cache line entry corresponding to the page, the cache line entry comprised in a cache, responsive to a determination that the first GA indicator matches the second GA indicator, returning first data in the cache line entry for the page, and responsive to a determination that the first GA indicator does not match the second GA indicator, applying, by the processing device, an eviction policy to the cache line entry based on whether the cache line is indicated as a dirty cache line and accessing second data in the memory device for the page.

In Example 13, the subject matter of Example 12 can optionally include wherein applying the eviction policy further comprises responsive to the cache line entry being indicated as a dirty cache line, writing back the first data in the cache line entry to the memory device and performing a self-snoop to read the second data in the memory device for the page and add the second data to the cache. In Example 14, the subject matter of any one of Examples 12-13 can optionally include wherein responsive to the GA indicator being set, the first data is encrypted by a memory encryption engine (MEE) prior to writing the first data back to the memory device.

In Example 15, the subject matter of any one of Examples 12-14 can optionally include wherein responsive to the GA indicator being clear, the first data bypasses a memory encryption engine (MEE) when writing the first data back to the memory device. In Example 16, the subject matter of any one of Examples 12-15 can optionally include wherein applying the eviction policy further comprises responsive to the cache line entry being indicated as a clean cache line, invalidating the first data in the cache line entry and performing a self-snoop to read the second data in the memory device for the page and add the second data to the cache.

In Example 17, the subject matter of any one of Examples 12-16 can optionally include wherein the second GA indicator is separate from a tag corresponding to an address for the page in the cache line entry, the tag used for lookup operations in the cache. In Example 18, the subject matter of any one of Examples 12-17 can optionally include wherein the second GA indicator comprises a bit in the cache line entry.

In Example 19, the subject matter of any one of Examples 12-18 can optionally include wherein the first GA indicator is obtained from a translation lookaside buffer (TLB) entry for an address of the page. In Example 20, the subject matter of any one of Examples 12-19 can optionally include wherein the first GA indicator comprises a bit in the TLB entry.

In Example 21, the subject matter of any one of Examples 12-20 can optionally include wherein the processing device is further to, responsive to failure to locate the cache line entry for the page in the cache, accessing the memory device to obtain the second data for the page. In Example 22, the subject matter of any one of Examples 12-21 can optionally include wherein the processing device further comprises a page miss handler (PMH) to, responsive to determining that a translation lookaside buffer (TLB) of the processing device does not comprise a TLB entry corresponding to the page and prior to determining whether the first GA indicator matches the second GA indicator: perform a page walk to obtain an address for the page, perform secure memory access checks for the memory access request to the page, generated the first GA indicator based on the secure access memory checks, and add a new TLB entry to the TLB, the new TLB entry comprising the first GA indicator.

Example 23 is a system for implementing cache behavior for secure memory repartitioning systems In Example 23, the system includes a memory device to store pages and a processing device operably coupled to the memory device, where the processing device comprises a cache and a memory encryption engine. Further to Example 23, the processing device is to receive a memory access request to a page in the memory device, the memory access request comprising a first guarded attribute (GA) indicator indicating whether the page is a secure page belonging to an enclave, determine whether the first GA indicator matches a second GA indicator in a cache line entry corresponding to the page, the cache line entry comprised in a cache, responsive to a determination that the first GA indicator matches the second GA indicator, return first data in the cache line entry for the page, and responsive to a determination that the first GA indicator does not match the second GA indicator, apply an eviction policy to the cache line entry based on whether the cache line is indicated as a dirty cache line and accessing second data in the memory device for the page.

In Example 24, the subject matter of Example 23 can optionally include wherein the processing device to apply the eviction policy further comprises the processing device to, responsive to the cache line entry being indicated as a dirty cache line, write back the first data in the cache line entry to the memory device and performing a self-snoop to read the second data in the memory device for the page and add the second data to the cache. In Example 25, the subject matter of any one of Examples 23-24 can optionally include wherein responsive to the GA indicator being set, the first data is encrypted by a memory encryption engine (MEE) prior to writing the first data back to the memory device.

In Example 26, the subject matter of any one of Examples 23-25 can optionally include wherein responsive to the GA indicator being clear, the first data bypasses a memory encryption engine (MEE) when writing the first data back to the memory device. In Example 27, the subject matter of any one of Examples 23-26 can optionally include wherein the processing device to apply the eviction policy further comprises the processing device to, responsive to the cache line entry being indicated as a clean cache line, invalidate the first data in the cache line entry and performing a self-snoop to read the second data in the memory device for the page and add the second data to the cache.

In Example 28, the subject matter of any one of Examples 23-27 can optionally include wherein the second GA indicator is separate from a tag corresponding to an address for the page in the cache line entry, the tag used for lookup operations in the cache. In Example 29, the subject matter of any one of Examples 23-28 can optionally include wherein the second GA indicator comprises a bit in the cache line entry. In Example 30, the subject matter of any one of Examples 23-29 can optionally include wherein the first GA indicator is obtained from a translation lookaside buffer (TLB) entry for an address of the page.

In Example 31, the subject matter of any one of Examples 23-30 can optionally include wherein the first GA indicator comprises a bit in the TLB entry. In Example 32, the subject matter of any one of Examples 23-31 can optionally include wherein the processing device is further to, responsive to failure to locate the cache line entry for the page in the cache, access the memory device to obtain the second data for the page.

In Example 33, the subject matter of any one of Examples 23-32 can optionally include wherein the processing device further comprises a page miss handler (PMH) to, responsive to determining that a translation lookaside buffer (TLB) of the processing device does not comprise a TLB entry corresponding to the page and prior to determining whether the first GA indicator matches the second GA indicator: perform a page walk to obtain an address for the page, perform secure memory access checks for the memory access request to the page, generate the first GA indicator based on the secure access memory checks, and add a new TLB entry to the TLB, the new TLB entry comprising the first GA indicator. All optional features of the system described above may also be implemented with respect to the method or process described herein.

Example 34 is a non-transitory computer-readable medium for implementing cache behavior for secure memory repartitioning systems. In Example 34, the non-transitory machine-readable medium includes data that, when accessed by a processing device, cause the processing device to perform operations comprising receiving, by the processing device, a memory access request to a page in a memory device communicably coupled to the processing device, the memory access request comprising a first guarded attribute (GA) indicator indicating whether the page is a secure page belonging to an enclave, determining, by the processing device, whether the first GA indicator matches a second GA indicator in a cache line entry corresponding to the page, the cache line entry comprised in a cache, responsive to a determination that the first GA indicator matches the second GA indicator, returning first data in the cache line entry for the page, and responsive to a determination that the first GA indicator does not match the second GA indicator, applying, by the processing device, an eviction policy to the cache line entry based on whether the cache line is indicated as a dirty cache line and accessing second data in the memory device for the page.

In Example 35, the subject matter of Example 34 can optionally include wherein applying the eviction policy further comprises responsive to the cache line entry being indicated as a dirty cache line, writing back the first data in the cache line entry to the memory device and performing a self-snoop to read the second data in the memory device for the page and add the second data to the cache. In Example 36, the subject matter of Examples 34-35 can optionally include wherein responsive to the GA indicator being set, the first data is encrypted by a memory encryption engine (MEE) prior to writing the first data back to the memory device. In Example 37, the subject matter of Examples 34-36 can optionally include wherein responsive to the GA indicator being clear, the first data bypasses a memory encryption engine (MEE) when writing the first data back to the memory device.

In Example 38, the subject matter of Examples 34-37 can optionally include wherein applying the eviction policy further comprises responsive to the cache line entry being indicated as a clean cache line, invalidating the first data in the cache line entry and performing a self-snoop to read the second data in the memory device for the page and add the second data to the cache. In Example 39, the subject matter of Examples 34-38 can optionally include wherein the second GA indicator is separate from a tag corresponding to an address for the page in the cache line entry, the tag used for lookup operations in the cache. In Example 40, the subject matter of Examples 34-39 can optionally include wherein the second GA indicator comprises a bit in the cache line entry.

In Example 41, the subject matter of Examples 34-40 can optionally include wherein the first GA indicator is obtained from a translation lookaside buffer (TLB) entry for an address of the page. In Example 42, the subject matter of Examples 34-41 can optionally include wherein the first GA indicator comprises a bit in the TLB entry. In Example 43, the subject matter of Examples 34-42 can optionally include wherein the processing device is further to, responsive to failure to locate the cache line entry for the page in the cache, accessing the memory device to obtain the second data for the page.

In Example 44, the subject matter of Examples 34-43 can optionally include wherein the processing device further comprises a page miss handler (PMH) to, responsive to determining that a translation lookaside buffer (TLB) of the processing device does not comprise a TLB entry corresponding to the page and prior to determining whether the first GA indicator matches the second GA indicator: perform a page walk to obtain an address for the page, perform secure memory access checks for the memory access request to the page, generate the first GA indicator based on the secure access memory checks, and add a new TLB entry to the TLB, the new TLB entry comprising the first GA indicator.

Example 45 is an apparatus for implementing cache behavior for secure memory repartitioning systems comprising means for receiving a memory access request to a page in a memory device communicably coupled to the processing device, the memory access request comprising a first guarded attribute (GA) indicator indicating whether the page is a secure page belonging to an enclave, means for determining, by the processing device, whether the first GA indicator matches a second GA indicator in a cache line entry corresponding to the page, the cache line entry comprised in a cache, means for returning, responsive to a determination that the first GA indicator matches the second GA indicator, first data in the cache line entry for the page, and means for applying, responsive to a determination that the first GA indicator does not match the second GA indicator, an eviction policy to the cache line entry based on whether the cache line is indicated as a dirty cache line and accessing second data in the memory device for the page. In Example 46, the subject matter of Example 45 can optionally include the apparatus further configured to perform the method of any one of the Examples 13 to 22.

Example 47 is at least one machine readable medium comprising a plurality of instructions that in response to being executed on a computing device, cause the computing device to carry out a method according to any one of Examples 12-22. Example 48 is an apparatus for implementing cache behavior for secure memory repartitioning systems, configured to perform the method of any one of Examples 12-22. Example 49 is an apparatus for implementing cache behavior for secure memory repartitioning systems, comprising means for performing the method of any one of claims 12 to 22. Specifics in the Examples may be used anywhere in one or more embodiments.

While the disclosure has been described with respect to a limited number of implementations, those skilled in the art will appreciate numerous modifications and variations therefrom. It is intended that the appended claims cover all such modifications and variations as fall within the true spirit and scope of this present disclosure.

In the description herein, numerous specific details are set forth, such as examples of specific types of processing devices and system configurations, specific hardware structures, specific architectural and micro architectural details, specific register configurations, specific instruction types, specific system components, specific measurements/heights, specific processing device pipeline stages and operation etc. in order to provide a thorough understanding of the present disclosure. It will be apparent, however, to one skilled in the art that these specific details need not be employed to practice the present disclosure. In other instances, well known components or methods, such as specific and alternative processing device architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system have not been described in detail in order to avoid unnecessarily obscuring the present disclosure.

The implementations are described with reference to secure memory repartitioning technologies in specific integrated circuits, such as in computing platforms or microprocessing devices. The implementations may also be applicable to other types of integrated circuits and programmable logic devices. For example, the disclosed implementations are not limited to desktop computer systems or portable computers, such as the Intel® Ultrabooks™ computers. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processing device (DSP), a system on a chip, network computers (NetPC), set-top boxes, network hubs, wide area network (WAN) switches, or any other system that can perform the functions and operations taught below. It is described that the system can be any kind of computer or embedded system. The disclosed implementations may especially be used for low-end devices, like wearable devices (e.g., watches), electronic implants, sensory and control infrastructure devices, controllers, supervisory control and data acquisition (SCADA) systems, or the like. Moreover, the apparatuses, methods, and systems described herein are not limited to physical computing devices, but may also relate to software optimizations for energy conservation and efficiency. As will become readily apparent in the description below, the implementations of methods, apparatuses, and systems described herein (whether in reference to hardware, firmware, software, or a combination thereof) are vital to a ‘green technology’ future balanced with performance considerations.

Although the implementations herein are described with reference to a processing device, other implementations are applicable to other types of integrated circuits and logic devices. Similar techniques and teachings of implementations of the present disclosure can be applied to other types of circuits or semiconductor devices that can benefit from higher pipeline throughput and improved performance. The teachings of implementations of the present disclosure are applicable to any processing device or machine that performs data manipulations. However, the present disclosure is not limited to processing devices or machines that perform 512 bit, 256 bit, 128 bit, 64 bit, 32 bit, or 16 bit data operations and can be applied to any processing device and machine in which manipulation or management of data is performed. In addition, the description herein provides examples, and the accompanying drawings show various examples for the purposes of illustration. However, these examples should not be construed in a limiting sense as they are merely intended to provide examples of implementations of the disclosure rather than to provide an exhaustive list of all possible implementations of implementations of the disclosure.

Although the below examples describe instruction handling and distribution in the context of execution units and logic circuits, other implementations of the disclosure can be accomplished by way of a data or instructions stored on a machine-readable, tangible medium, which when performed by a machine cause the machine to perform functions consistent with at least one implementation of the disclosure. In one implementation, functions associated with implementations of the disclosure are embodied in machine-executable instructions. The instructions can be used to cause a general-purpose or special-purpose processing device that is programmed with the instructions to perform the steps of the present disclosure. Implementations of the disclosure may be provided as a computer program product or software which may include a machine or computer-readable medium having stored thereon instructions which may be used to program a computer (or other electronic devices) to perform one or more operations according to implementations of the disclosure. Alternatively, operations of implementations of the disclosure might be performed by specific hardware components that contain fixed-function logic for performing the operations, or by any combination of programmed computer components and fixed-function hardware components.

Instructions used to program logic to perform implementations of the disclosure can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of implementations of the disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one implementation, refers to the hardware, which is specifically configured to recognize and/or execute the code to be held on a non-transitory medium. Furthermore, in another implementation, use of a module refers to the non-transitory medium including the code, which is specifically adapted to be executed by the microcontroller to perform predetermined operations. And as can be inferred, in yet another implementation, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one implementation, use of the term logic includes hardware, such as transistors, registers, or other hardware, such as programmable logic devices.

Use of the phrase ‘configured to,’ in one implementation, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one implementation, refers to some apparatus, logic, hardware, and/or element designed in such a way to enable use of the apparatus, logic, hardware, and/or element in a specified manner. Note as above that use of to, capable to, or operable to, in one implementation, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one implementation, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one implementation, refer to a default and an updated value or state, respectively. For example, a default value potentially includes a high logical value, i.e. reset, while an updated value potentially includes a low logical value, i.e. set. Note that any combination of values may be utilized to represent any number of states.

The implementations of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform implementations of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

Reference throughout this specification to “one implementation” or “an implementation” or “in one embodiment” or “an embodiment” means that a particular feature, structure, or characteristic described in connection with the implementation is included in at least one implementation of the disclosure. Thus, the appearances of the phrases “in one implementation” or “in an implementation” or “in one embodiment” or “an embodiment” in various places throughout this specification are not necessarily all referring to the same implementation or embodiment. Furthermore, the particular features, structures, or characteristics may be combined in any suitable manner in one or more implementations.

In the foregoing specification, a detailed description has been given with reference to specific exemplary implementations. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of implementation and other exemplarily language does not necessarily refer to the same implementation or the same example, but may refer to different and distinct implementations, as well as potentially the same implementation.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “defining,” “receiving,” “determining,” “issuing,” “linking,” “associating,” “obtaining,” “authenticating,” “prohibiting,” “executing,” “requesting,” “communicating,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and may not necessarily have an ordinal meaning according to their numerical designation.

What is claimed is:

1. A processing device comprising:
a processing core; and
a memory controller coupled between the processor core and a memory device, wherein the memory device comprises a memory range comprising a section of convertible pages that are convertible to secure pages or non-secure pages, and wherein the processor core is to:
receive a memory access request to a page in the memory device, the memory access request comprising a first guarded attribute (GA) indicator indicating whether the page is a secure page belonging to an enclave;
determine whether the first GA indicator matches a second GA indicator in a cache line entry corresponding to the page, the cache line entry comprised in a cache;
responsive to a determination that the first GA indicator matches the second GA indicator, return first data in the cache line entry for the page; and
responsive to a determination that the first GA indicator does not match the second GA indicator, apply an eviction policy to the cache line entry based on whether the cache line is indicated as a dirty cache line and accessing second data in the memory device for the page.

2. The processing device of claim 1, wherein the processing device to apply the eviction policy further comprises the processing device to, responsive to the cache line entry being indicated as a dirty cache line, write back the first data in the cache line entry to the memory device and performing a self-snoop to read the second data in the memory device for the page and add the second data to the cache.

3. The processing device of claim 2, wherein responsive to the GA indicator being set, the first data is encrypted by a memory encryption engine (MEE) prior to writing the first data back to the memory device.

4. The processing device of claim 2, wherein responsive to the GA indicator being clear, the first data bypasses a memory encryption engine (MEE) when writing the first data back to the memory device.

5. The processing device of claim 1, wherein the processing device to apply the eviction policy further comprises the processing device to, responsive to the cache line entry being indicated as a clean cache line, invalidate the first data in the cache line entry and performing a self-snoop to read the second data in the memory device for the page and add the second data to the cache.

6. The processing device of claim 1, wherein the second GA indicator is separate from a tag corresponding to an address for the page in the cache line entry, the tag used for lookup operations in the cache.

7. The processing device of claim 6, wherein the second GA indicator comprises a bit in the cache line entry.

8. The processing device of claim 1, wherein the first GA indicator is obtained from a translation lookaside buffer (TLB) entry for an address of the page.

9. The processing device of claim 8, wherein the first GA indicator comprises a bit in the TLB entry.

10. The processing device of claim 1, wherein the processing device is further to, responsive to failure to locate the cache line entry for the page in the cache, access the memory device to obtain the second data for the page.

11. The processing device of claim 1, wherein the processing device further comprises a page miss handler (PMH) to, responsive to determining that a translation lookaside buffer (TLB) of the processing device does not comprise a TLB entry corresponding to the page and prior to determining whether the first GA indicator matches the second GA indicator:
perform a page walk to obtain an address for the page;
perform secure memory access checks for the memory access request to the page;
generate the first GA indicator based on the secure access memory checks; and
add a new TLB entry to the TLB, the new TLB entry comprising the first GA indicator.

12. A method, comprising:
receiving, by a processing device, a memory access request to a page in a memory device communicably coupled to the processing device, the memory access request comprising a first guarded attribute (GA) indicator indicating whether the page is a secure page belonging to an enclave;
determining, by the processing device, whether the first GA indicator matches a second GA indicator in a cache line entry corresponding to the page, the cache line entry comprised in a cache;
responsive to a determination that the first GA indicator matches the second GA indicator, returning first data in the cache line entry for the page; and
responsive to a determination that the first GA indicator does not match the second GA indicator, applying, by the processing device, an eviction policy to the cache line entry based on whether the cache line is indicated as a dirty cache line and accessing second data in the memory device for the page.

13. The method of claim 12, wherein applying the eviction policy further comprises responsive to the cache line entry being indicated as a dirty cache line, writing back the first data in the cache line entry to the memory device and performing a self-snoop to read the second data in the memory device for the page and add the second data to the cache.

14. The method of claim 12, wherein applying the eviction policy further comprises responsive to the cache line entry being indicated as a clean cache line, invalidating the first data in the cache line entry and performing a self-snoop to read the second data in the memory device for the page and add the second data to the cache.

15. The method of claim 12, wherein the second GA indicator is separate from a tag corresponding to an address for the page in the cache line entry, the tag used for lookup operations in the cache.

16. The method of claim 12, wherein the processing device further comprises a page miss handler (PMH) to, responsive to determining that a translation lookaside buffer (TLB) of the processing device does not comprise a TLB entry corresponding to the page and prior to determining whether the first GA indicator matches the second GA indicator:
perform a page walk to obtain an address for the page;
perform secure memory access checks for the memory access request to the page;
generated the first GA indicator based on the secure access memory checks; and
add a new TLB entry to the TLB, the new TLB entry comprising the first GA indicator.

17. An system comprising:
a memory device to store pages; and
a processing device operably coupled to the memory device, the processing device comprising a cache and a memory encryption engine, and the processing device to: receive a memory access request to a page in the memory device, the memory access request comprising a first guarded attribute (GA) indicator indicating whether the page is a secure page belonging to an enclave;
determine whether the first GA indicator matches a second GA indicator in a cache line entry corresponding to the page, the cache line entry comprised in a cache;
responsive to a determination that the first GA indicator matches the second GA indicator, return first data in the cache line entry for the page; and
responsive to a determination that the first GA indicator does not match the second GA indicator, apply an eviction policy to the cache line entry based on whether the cache line is indicated as a dirty cache line and accessing second data in the memory device for the page.

18. The system of claim 17, wherein the processing device to apply the eviction policy further comprises the processing device to, responsive to the cache line entry being indicated as a dirty cache line, write back the first data in the cache line entry to the memory device and performing a self-snoop to read the second data in the memory device for the page and add the second data to the cache.

19. The system of claim 17, wherein the processing device to apply the eviction policy further comprises the processing device to, responsive to the cache line entry being indicated as a clean cache line, invalidate the first data in the cache line entry and performing a self-snoop to read the second data in the memory device for the page and add the second data to the cache.

20. The system of claim 17, wherein the processing device further comprises a page miss handler (PMH) to, responsive to determining that a translation lookaside buffer (TLB) of the processing device does not comprise a TLB entry corresponding to the page and prior to determining whether the first GA indicator matches the second GA indicator:
perform a page walk to obtain an address for the page;
perform secure memory access checks for the memory access request to the page;
generate the first GA indicator based on the secure access memory checks; and
add a new TLB entry to the TLB, the new TLB entry comprising the first GA indicator.
